(19) United States
(12) Patent Application Publication
(10) Pub. No.: US 2026/0296304 A1
(43) Pub. Date: Oct. 1, 2026

(54) A GEAR SHIFT SYSTEM

(71) Applicant: JAGUAR LAND ROVER LIMITED, Whitley Coventry Warwickshire (GB)

(72) Inventors: Artist BEQA, Whitley Coventry Warwickshire (GB); Charlie ENGLISH, Whitley Coventry Warwickshire (GB)

(21) Appl. No.: 19/476,068

(22) PCT Filed: Apr. 11, 2024
(86) PCT No.: PCT/EP2024/059795

§ 371 Date: Oct. 16, 2025

(30) Foreign Application Priority Data
Apr. 17, 2023 (GB) 2305623.7

(51) Int. Cl. B60Q 3/283; B60K 20/06; B60Q 3/62; B60Q 3/80

(52) U.S. Cl. CPC B60Q 3/283; B60K 20/06; B60Q 3/62; B60Q 3/80

(57) ABSTRACT

A gear shift system for a vehicle comprises a steering wheel. The gear shift system comprises a plurality of gear shift paddles associated with the steering wheel. Each of the plurality of gear shift paddles are operable by a user of the vehicle to request a gear shift. The plurality of gear shift paddles each comprise a illuminable portion.

### CROSS REFERENCE TO RELATED APPLICATIONS

The present application is a U.S. National Phase of International Application No. PCT/EP2024/059795 entitled “A GEAR SHIFT SYSTEM,” and filed on Apr. 11, 2024. International Application No. PCT/EP2024/059795 claims priority to Great Britain Patent Application No. 2305623.7 filed on Apr. 17, 2023. The entire contents of each of the above-listed applications are hereby incorporated by reference for all purposes.

### TECHNICAL FIELD

The present disclosure relates to a gear shift system. Aspects of the invention relate to a gear shift system, a driving system, a gear shift paddle, a second drive mode kit of parts and a vehicle.

### BACKGROUND

It is known to provide gear shift paddles configured to enable a user of a vehicle to request a gear change from the transmission of the vehicle. Such gear shift paddles are associated with the steering wheel of the vehicle.

It is an aim of the present invention to address one or more of the disadvantages associated with the prior art.

### SUMMARY OF THE INVENTION

Aspects and embodiments of the invention provide a gear shift system, a driving system, a gear shift paddle, a second drive mode kit of parts and a vehicle as claimed in the appended claims.

According to an aspect of the present invention there is provided a gear shift system, the gear shift system comprising a gear shift paddle, the gear shift paddle being operable by a user of the vehicle to request a gear shift, wherein the gear shift paddle comprises an illuminable portion.

According to another aspect of the present invention there is provided a gear shift system, the gear shift system comprising a plurality of gear shift paddle, each of the plurality of gear shift paddles being operable by a user of the vehicle to request a gear shift wherein the plurality of gear shift paddles each comprise a illuminable portion.

According to another aspect of the present invention there is provided a gear shift system for a vehicle comprising a steering wheel, the gear shift system comprising a plurality of gear shift paddles associated with the steering wheel, each of the plurality of gear shift paddles being operable by a user of the vehicle to request a gear shift wherein the plurality of gear shift paddles each comprise a illuminable portion.

The illuminable portion may be configured to selectively illuminate in dependence on a given vehicle drive mode, wherein in a first drive mode the illuminable portion of each of the plurality of gear shift paddles may illuminate in a first colour, and in a second drive mode the illuminable portion of each of the plurality of gear shift paddles may illuminate in a second, different, colour. Optionally the first colour is white. Optionally the second colour is red.

Each gear shift paddle of the plurality of gear shift paddles may comprise a light source. The light source may be an LED. The light source may be configured to illuminate the illuminable portion of each gear shift paddle of the plurality of gear shift paddles.

The illuminable portion may comprise a transparent material or a translucent material.

Each gear shift paddle of the plurality of gear shift paddles may comprise a light guide, the light guide may be configured to transmit light from the LED to illuminate the illuminable portion of each of the gear shift paddles. The illuminable portion may comprise the LED.

The gear shift requested by one of the plurality of gear shift paddles may be a change-up gear shift, configured to cause a transmission of the vehicle to change to a higher gear. The gear shift requested by another of the plurality of gear shift paddles may be a change-down gear shift function, configured to cause a transmission of the vehicle to change to a lower gear.

The gear shift requested by operation of each of the plurality of gear shift paddles in a first direction may be a change-up gear shift, configured to cause a transmission of the vehicle to change to a higher gear. The gear shift requested by operation of each of the plurality of gear shift paddles in a second, different, direction may be a change-down gear shift, configured to cause a transmission of the vehicle to change to a lower gear.

In a third drive mode the illuminable portion of each of the plurality of gear shift paddles may not illuminate.

The illuminable portion may comprise a light obscuration region so that light emitted through the illuminable portion has a non-uniform appearance.

The light obscuration region may comprise an indicator indicative of gear shift direction selectable by operation of the gear shift paddle. Optionally, the indicator is an engraved or etched indicator.

According to another aspect of the present invention there is provided a driving system for a vehicle, the driving system comprising the gear shift system and a steering wheel. The steering wheel comprises a second drive mode activation button configured to cause the vehicle to transition from a first drive mode to a second drive mode. The second drive mode activation button comprises a second drive mode activation button illuminable portion, the second drive mode activation button illuminable portion configured to selectively illuminate in dependence on a given vehicle drive mode. In a first drive mode the illuminable portion of the second drive mode activation button illuminates in a first colour, and in a second drive mode the illuminable portion of the second drive mode activation button illuminates in a second, different, colour.

Optionally the plurality of gear shift paddles may not be rotatably coupled to the steering wheel. Alternatively, the plurality of gear shift paddles may be rotatably coupled to steering wheel.

According to another aspect of the present invention there is provided a vehicle comprising the gear shift system or the driving system.

Optionally, in each of the first, second and third drive modes, a state of a plurality of further vehicle systems are modified.

According to another aspect of the present invention there is provided a gear shift paddle for requesting a gear shift of a vehicle, the gear shift paddle comprising an opaque portion and an illuminable portion, the illuminable portion configured to receive light and emit the light for observation by a user of the vehicle.

According to another aspect of the present invention there is provided a gear shift paddle for requesting a gear shift of a vehicle, the gear shift paddle comprising an opaque portion, the opaque portion comprising a light guide and an illuminable portion, the illuminable portion configured to receive light transmitted through the light guide and emit the light for observation by a user of the vehicle.

The illuminable portion may comprise a transparent material or a translucent material.

The illuminable portion may further comprise a light obscuration region so that the light, when emitted, has a non-uniform appearance. The light obscuration region may be an indicator indicative of gear shift direction selectable by operation of the gear shift paddle.

The gear shift paddle may comprise a light source configured to provide the light to the light guide. The light source may be an LED. The opaque portion may comprise the light source.

The illuminable portion may be configured to selectively illuminate in dependence on a given vehicle drive mode, wherein in a first drive mode the illuminable portion of the gear shift paddle may illuminate in a first colour, and in a second drive mode the illuminable portion of the gear shift paddle may illuminate in a second, different, colour.

The light obscuration region may be configured to refract the light received via the light guide for observation by the user. Alternatively the light obscuration region may be configured to reflect the light received via the light guide for observation by the user.

The light obscuration region may be configured to block the light received via the light guide for observation by the user.

According to another aspect of the present invention there is provided a second drive mode kit of parts, the second drive mode kit of parts comprising a plurality of the gear shift paddle of any preceding claim and a second drive mode activation button configured to cause the vehicle to transition from a first drive mode to a second drive mode, and wherein the second drive mode activation button comprises a second drive mode activation button illuminable portion, the illuminable portion of the second drive mode activation button configured to selectively illuminate in dependence on a given vehicle drive mode, wherein in a first drive mode the illuminable portion of the second drive mode activation button illuminates in a first colour, and in a second drive mode the illuminable portion of the second drive mode activation button illuminates in a second, different, colour.

According to another aspect of the present invention there is provided a gear shift system for a vehicle, the gear shift system comprising a second drive mode kit of parts, and a steering wheel, wherein each of the plurality of gear shift paddles are operable by a user of the vehicle to request a gear shift and the plurality of gear shift paddles and the second drive mode activation button are associated with the steering wheel.

The first colour of the illuminable portion of the plurality of gear shift paddle and the first colour of the illuminable portion of the second drive mode activation button may be the same colour, and the second colour of the illuminable portion of the plurality of gear shift paddle; and the second colour of the illuminable portion of the second drive mode activation button may be the same colour, different to the first colour.

According to another aspect of the present invention there is provided a vehicle comprising: a plurality of gear shift paddle, the second drive mode kit of parts, or the gear shift system.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle according to an embodiment of the invention;

FIG. 2 shows a gear shift paddle according to an embodiment of the invention;

FIG. 3 shows a gear shift system according to an embodiment of the invention;

FIG. 4 shows a gear shift system according to a further embodiment of the invention; and

FIG. 5 shows an illuminable portion of a gear shift paddle according to embodiments of the invention.

### DETAILED DESCRIPTION

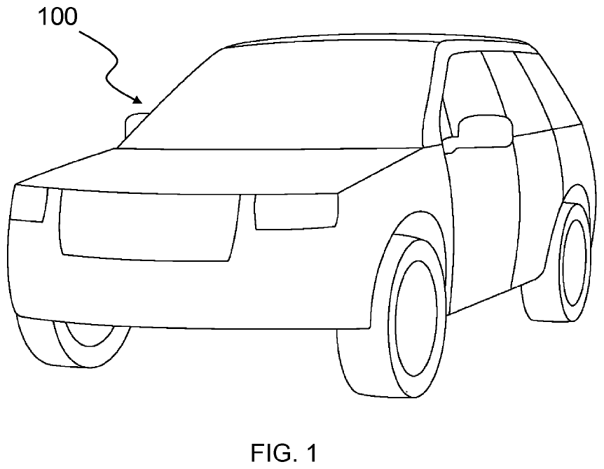

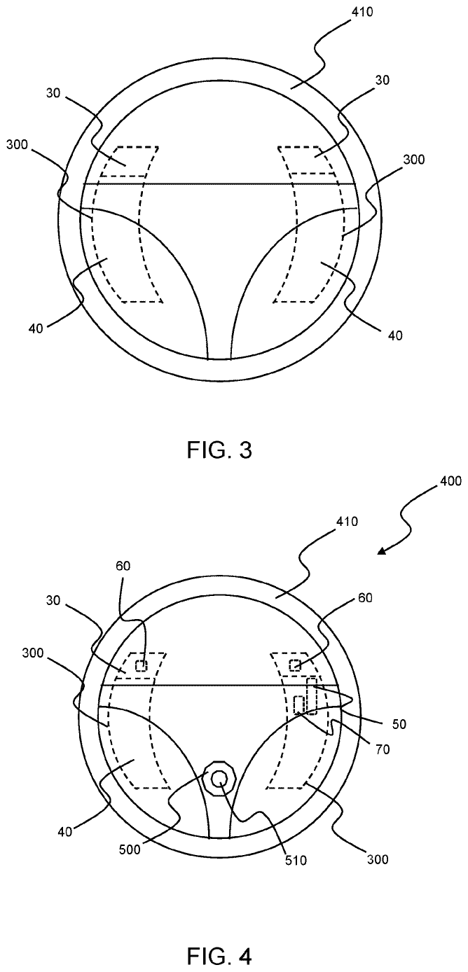

A gear shift system in accordance with an embodiment of the present invention is described herein with reference to the accompanying FIG. 3. As shown in FIG. 1, the steering system is installed in a vehicle 100.

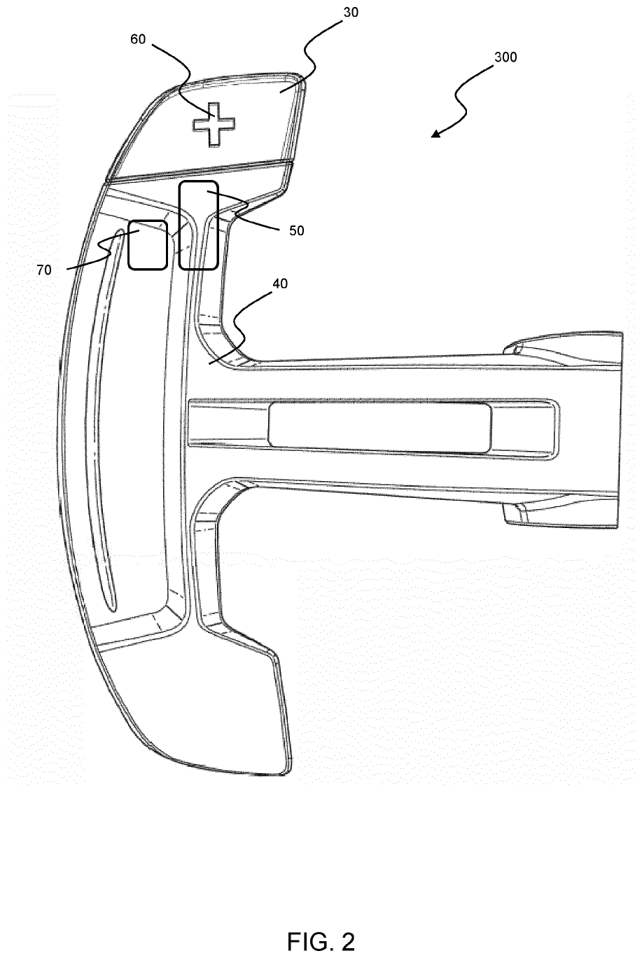

FIG. 1 illustrates a vehicle 100 according to an embodiment of the present invention. The vehicle 100 comprises a gear shift paddle 300 as illustrated in FIG. 2. The vehicle 100 comprises a transmission, and the transmission comprises a plurality of selectable driving gears. In an automatic mode, the transmission control system, which may comprise one or more controller, selects the driving gear most suitable for the current driving mode of the vehicle 100, the engine speed (rpm), the current speed of the vehicle, and the torque requested by the driving controller of the vehicle, at least. The driving controller of the vehicle may be a driver of the vehicle, or an autonomous system configured to control the speed of the vehicle.

The transmission of the vehicle 100 also comprises a manual mode. In the manual mode, a plurality of gear shift paddles 300 are operable by the driver (or user) of the vehicle. Operation of the gear shift paddles 300 will cause the transmission of the vehicle 100 to change up, that is perform a change-up gear shift. A change-up gear shift is configured to cause the transmission of the vehicle 100 to change to a higher gear. Another operation of the gear shift paddles 300 will cause the transmission of the vehicle 100 to change down, that is perform a change-down gear shift. A change-down gear shift is configured to cause a transmission of the vehicle 100 to change to a lower gear. Operation of the gear shift paddles 300 will be understood to describe the action of a user of vehicle actuating or moving the paddle.

In an embodiment of the invention, operation of one of the plurality of gear shift paddles 300 by the user of the vehicle, in either direction, will cause the vehicle to shift up. In this embodiment, operation of another of the plurality of gear shift paddles 300 by the user of the vehicle, in either direction, will cause the vehicle to shift down.

In another embodiment of the invention, operation of any of the plurality of gear shift paddles 300 by the user of the vehicle in a first direction will cause the vehicle to shift up. In this embodiment, operation of any of the plurality of gear shift paddles 300 by the user of the vehicle in a second direction, opposite the first direction, will cause the vehicle to shift down.

A gear shift paddle 300 is shown in FIG. 2. The gear shift paddle 300 is suitable for requesting a gear shift of a vehicle 100. The gear shift paddle 300 comprises an opaque portion 40. The opaque portion 40 is configured such that it may contain a number of the components necessary for the functionality of the gear shift paddle 300, whilst shielding those components from the view of a user of the vehicle. The opaque portion 40 may comprise components such as, for example, one or more printed circuit board, one or more wiring harness, one or more cover portion, one or more heatsink, one or more light source, one or more adhesive path, and one or more electrical or physical connector. An LED 70 is an example of a light source. The gear shift paddle 300 further comprises an illuminable portion 30. The illuminable portion 30 may be formed from a transparent material or a translucent material. The material of the illuminable portion 30 may be a polycarbonate, or other plastics material. The illuminable portion 30 may have a substantially ‘glass-like’ appearance, but be fabricated from such a plastics material to reduce weight.

The opaque portion 40 comprises a light guide 50, wherein the light guide 50 is configured to transmit light from the light source to the illuminable portion 30. The light guide 50 is configured such that light may pass directly from the light source, and be emitted by the illuminable portion 30. The light guide 50 is not visible to the user of the vehicle 100, and is configured to enable the illuminable portion 30 to emit light for observation by the user of the vehicle 100. The light guide 50 is formed from a plastics material, such as polycarbonate, and is configured such that the light emitted from the light source 70 is guided through the opaque portion 40 to illuminate the illuminable portion 30.

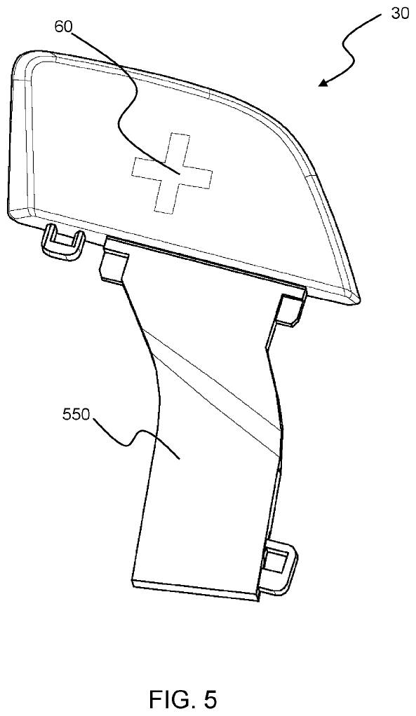

As shown in FIG. 5, the illuminable portion 30 comprises a blade portion 550 configured to protrude into the opaque portion 40. The blade portion 550 of the illuminable portion 30 is shielded from the view of the user by the opaque portion 40. The blade portion 550 is configured to maintain a connection between the illuminable portion 30 and the opaque portion 40. The blade portion 550 is configured to act as the light guide 50.

The illuminable portion 30 may comprise a light obscuration region 60 so that the light, when emitted, has a non-uniform appearance. The light obscuration region 60 may be formed by coating a portion of the illuminable portion 30 with an opaque material, such as a paint or ink. Alternatively, the light obscuration region 60 may be formed by etching or engraving the illuminable portion 30.

The light obscuration region 60 may be an indicator indicative of gear shift direction selectable by operation of the gear shift paddle. In embodiments where different paddle of the plurality of gear shift paddle 300 are operable to perform a gear shift in a given direction, the indicator may be a plus symbol (+) to indicate a shift up or upshift on one of the plurality of gear shift paddle 300, and the indicator may be a minus symbol (−) to indicate a shift down or downshift on another of the plurality of gear shift paddle 300. In embodiments where different directional actuation of the plurality of gear shift paddle 300 is utilised in order to determine the directionality (i.e. upshift or downshift), the indicator may comprise a plus symbol and a directional arrow, for example, and a minus symbol and a directional arrow, for example. The directional arrows in embodiments represent the direction in which the gear shift paddle 300 must be actuated by the user of the vehicle in order to request the desired gear shift. The directional arrows in embodiments represent directions substantially opposite to each other.

As discussed, in embodiments, the light source is an LED 70. The LED 70 may be contained within the opaque portion 40, or may be contained within the illuminable portion 30. The LED 70 is configured to provide light to the light guide 50, which will transmit the light, such that the light is emitted through the illuminable portion 30 for observation by the user of the vehicle 100.

The illuminable portion 30 is configured to selectively illuminate in dependence on a given vehicle drive mode. That is, the light source is configured to provide light of different colours to the illuminable portion for observation by the user of the vehicle 100. The light source is configured to provide light of two colours (referred to as a first colour and a second colour), at least. In embodiments, the light source is configured to provide light in more than two colours, such as, for example, a third colour.

The illuminable portion 30 is configured to illuminate in the first colour when the vehicle 100 is in a first drive mode. The illuminable portion 30 is configured to illuminate in the second colour when the vehicle 100 is in a second drive mode. The illuminable portion 30 is configured to not illuminate when the vehicle 100 is in a third drive mode.

A first drive mode of the vehicle 100 is a mode in which the transmission is in an automatic driving mode, as discussed, and the user of the vehicle 100 is able to override the selected driving gear by operation of the gear shift paddle 300. In embodiments, the first drive mode is a normal drive mode, a comfort drive mode. In this first drive mode, the illuminable portion 30 is configured to illuminate in the first colour. In embodiments, the first colour is substantially synchronised with an interior ambient lighting colour of the vehicle. In embodiments, the first colour is white. In embodiments, the illuminable portion 30 is configured to illuminate in the first colour in a fourth drive mode, or a fifth drive mode. The fourth drive mode may be an off-road drive mode in which the transmission is in an automatic driving mode, and a plurality of further vehicle systems are modified for off-road driving. In the fourth driving mode, optionally the user of the vehicle 100 is able to override the selected driving gear by operation of the gear shift paddle 300. The fifth drive mode may be an off-road drive mode in which the transmission is in a manual driving mode, and a plurality of further vehicle systems are modified for off-road driving.

The plurality of further vehicle systems may comprise a suspension control system, a throttle control system, a transmission control system and an engine exhaust control system.

A second drive mode of the vehicle 100 is a mode in which the transmission is in a manual driving mode, as discussed, and the user of the vehicle 100 is required to determine the selected driving gear by operation of the gear shift paddle 300. In embodiments, the second drive mode is a dynamic drive mode, a sport drive mode, a race drive mode or a track drive mode. In such embodiments, the second drive mode is a mode where a plurality of further vehicle systems are modified for high performance or spirited driving. Modification of the plurality of further vehicle systems for high performance driving may include increasing the responsiveness of the throttle control system, increasing the gear shift speed of the transmission control system and modifying the engine exhaust valve control system to open additional valves in the exhaust. In the discussed second drive mode, the illuminable portion 30 is configured to illuminate in the second colour. In embodiments, the second colour is substantially contrasting to an interior ambient lighting colour of the vehicle. In embodiments, the first colour is red. In embodiments, the illuminable portion 30 is configured to illuminate in the second colour in a sixth drive mode. In the sixth drive mode, the transmission of the vehicle is in an automatic driving mode, and the user of the vehicle 100 is able to override the selected driving gear by operation of the gear shift paddle 300. The sixth drive mode is a dynamic drive mode, a sport drive mode, a race drive mode or a track drive mode. In such embodiments, the sixth drive mode is a mode where a plurality of further vehicle systems are modified for high performance or spirited driving.

In such embodiments, where in the first drive mode of the vehicle 100 the illuminable portion 30 of the gear shift paddle illuminates in white, and in the second drive mode of the vehicle 100 the illuminable portion 30 of the gear shift paddle illuminates in red, the user of the vehicle is able to easily determine which drive mode is selected without the need to look at or interact with human machine interface devices of the vehicle, such as a display screen.

In a seventh drive mode, the illuminable portion 30 of the gear shift paddle 300 is configured to illuminate in the third colour. The seventh drive mode is an eco-mode of the vehicle, in which the plurality of further vehicle systems are modified for economical driving. In the seventh drive mode, the third colour is green. This indicates to the driver that the vehicle is configured to run in the most efficient mode, and acts to remind the driver of the vehicle as to the style in which the vehicle is presently configured.

The gear shift system 400 is configured such that in a third drive mode the illuminable portion 30 of each of the plurality of gear shift paddle 300 does not illuminate. In the third drive mode, the vehicle is configured to be in an automatic-only mode, in which operation of the gear shift paddles 300 by the user of the vehicle 100, serves no effect. Put another way, in the third drive mode, the vehicle 100 is in a fully automatic mode in which manual gear shifting is not permitted and the gear shift paddle 300 not illuminating serves to provide a simple reminder to the user of the vehicle that the vehicle 100 is in the fully automatic mode.

To summarise, in an embodiment, the illuminable portion 30 of the gear shift paddle 300 is configured to selectively illuminate in dependence on the selected drive mode of the vehicle 100. In the first drive mode, the illuminable portion 30 of the gear shift paddle 300 illuminates white to indicate ‘normal’ operation of the vehicle 100. In the second drive mode, the illuminable portion 30 of the gear shift paddle 300 illuminates red to indicate ‘high performance’ operation of the vehicle 100. In the third drive mode, the illuminable portion 30 of the gear shift paddle 300 does not illuminate to indicate that the vehicle 100 is operating in an ‘automatic-only’mode.

In embodiments, the light obscuration region 60 is configured to refract the light received via the light guide 50 for observation by the user. Alternatively or additionally, the light obscuration region 60 is configured to reflect the light received via the light guide 50 for observation by the user. Alternatively or additionally, the light obscuration region 60 is configured to block the light received via the light guide 50 for observation by the user. The light obscuration region may be formed by etching or engraving of the illuminable portion 30 of the gear shift paddle 300, such that when light passes through the light obscuration region 60, the light is modified, for example by reflection, refraction or blocking, such that the light observed by the user appears non-uniformly distributed. Put another way, the modification of the light passing through the light obscuration region 60 of the illuminable portion 30 highlights the light obscuration region 60, meaning in embodiments where the light obscuration region 60 is an indicator, the indicator is more easily visible to the user of the vehicle.

The plurality of gear shift paddle 300 are configured to be installed within a gear shift system 400 of a vehicle 100. In embodiments, two gear shift paddles 300 are installed in the vehicle, 100, proximal to the steering wheel 410 of the vehicle. In embodiments, the gear shift paddles 300 are installed on each lateral side of the steering wheel 410, such that a user of the vehicle may easily operate either of the gear shift paddle 300 whilst maintaining both hands on the steering wheel 410.

In addition to the steering wheel 410 and the plurality of gear shift paddle 300, in embodiments the vehicle may further comprise a second drive mode activation button 500. The second drive mode activation button 500 is configured, when installed in the vehicle, to activate the second drive mode, as discussed. The second drive mode activation button 500 may therefore cause the vehicle 100 to transition from the first drive mode to the second drive mode. The second drive mode activation button 500 may also cause the vehicle 100 to transition from any other mode to the second drive mode. For example, the second drive mode activation button 500 may cause the vehicle to transition from the third drive mode, the fourth drive mode, the fifth drive mode, the sixth drive mode, the seventh drive mode, or any other combination of further vehicle system configurations or modes, to the second drive mode. Utilising a single second drive mode activation button 500 to activate the second drive mode enables the user of the vehicle 100 to easily switch to the second drive mode, without having to access a series of options within the vehicle human-machine interface (HMI).

The second drive mode activation button 500 comprises a second drive mode activation button illuminable portion 510. The illuminable portion 510 of the second drive mode activation button is configured to selectively illuminate in dependence on a given vehicle drive mode. In a first drive mode the illuminable portion 510 of the second drive mode activation button illuminates in a first colour, and in a second drive mode the illuminable portion 510 of the second drive mode activation button illuminates in a second, different, colour. The second drive mode activation button 500 comprises a PCB with a light source. The light source may be one or more LEDs. The second drive mode activation button 500 also comprises a light guide, configured to transmit light from the light source to the illuminable portion 510. The illuminable portion 510 of the second drive mode activation button 500 may comprise an indicator. The indicator may be representative of the second drive mode activatable by user actuation of the second drive mode activation button 500. The indicator may be a logo or other similar indica, or a word such as ‘dynamic’, ‘track’ or ‘race’. The second drive mode activation button 500 may comprise a diffusor between the light guide and the illuminable portion 510. The diffusor diffuses the light from the light guide, meaning the illuminable portion 510 is evenly illuminated, ensuring clarity for the user of the vehicle as to the functionality of the second drive mode activation button 500. The second drive mode activation button 500 and the illuminable portion 510 of the second drive mode activation button 500 may be formed from a plastics material, such as polycarbonate, for example.

In an embodiment of the invention, there is provided a second drive mode kit of parts comprising a plurality of the gear shift paddle 300; and a second drive mode activation button 500.

In an embodiment of the invention, there is provided a gear shift system 400 comprising the second drive mode kit of parts and a steering wheel 410. Each of the plurality of gear shift paddles 300 are operable by a user of the vehicle 100 to request a gear shift and the plurality of gear shift paddles 300 and the second drive mode activation button 500 are associated with the steering wheel.

In embodiments of the invention whereby there is provided a plurality of gear shift paddle 300 and the second drive mode activation button 500 the first colour of the illuminable portion 30 of the plurality of gear shift paddle 300 and the first colour of the illuminable portion 510 of the second drive mode activation button 500 are the same colour, and the second colour of the illuminable portion 30 of the plurality of gear shift paddle 300; and the second colour of the illuminable portion 510 of the second drive mode activation button 500 are the same colour, different to the first colour.

Put another way, operation of the second drive mode activation button 500 by the user of the vehicle activates the second drive mode of the vehicle 100, which causes the illuminable portion 30 of the gear shift paddle 300 and the illuminable portion 510 of the second drive mode activation button 500 to both illuminate in the second colour, which in embodiments is red.

In embodiments, there is provided a vehicle 100 comprising a plurality of gear shift paddle 300, the second drive mode kit of parts or the gear shift system.

In embodiments, as discussed there is provided gear shift system 400 for a vehicle 100 comprising a steering wheel 410, comprising a plurality of gear shift paddles 300 associated with the steering wheel 410. Each of the plurality of gear shift paddles 300 is operable by a user of the vehicle to request a gear shift and each of the gear shift paddle 300 comprise an illuminable portion 30. In embodiments, the illuminable portion 30 of the gear shift paddles 300 is formed from a transparent or translucent material, which may be a plastics material such as polycarbonate. The illuminable portion 30 is suitable for illumination provided by a light source 70. The light source may be an LED 70.

In embodiments, the gear shift paddle 300 comprises a light guide 50, the light guide 50 is configured to transmit light from the LED 70 to illuminate the illuminable portion 30 of each of the gear shift paddles 300. In embodiments, the illuminable portion 30 comprises the LED 70.

In embodiments, the gear shift paddles are configured such that the gear shift requested by one of the plurality of gear shift paddles 300 is a change-up gear shift, configured to cause a transmission of the vehicle 100 to change to a higher gear, and the gear shift requested by another of the plurality of gear shift paddles 300 is a change-down gear shift function, configured to cause a transmission of the vehicle 100 to change to a lower gear. Put another way, the plurality of gear shift paddles 300 may be configured such that the left paddle causes the transmission of the vehicle to change down a gear, when operated either towards or away from the driver of the vehicle, and the right paddle causes the transmission of the vehicle to change up a gear, when operated either towards or away from the driver of the vehicle.

In an alternative embodiment, the gear shift requested by operation of any/each of the plurality of gear shift paddles 300 in a first direction is a change-up gear shift, configured to cause a transmission of the vehicle 100 to change to a higher gear, and the gear shift requested by operation of each of the plurality of gear shift paddles 300 in a second, different, direction is a change-down gear shift, configured to cause a transmission of the vehicle 100 to change to a lower gear. Put another way, in this alternative embodiment, operation of either the left or the right paddle in the direction towards the driver of the vehicle will cause the transmission of the vehicle 100 to change down a gear, and operation of either the left or the right paddle in the direction away the driver of the vehicle will cause the transmission of the vehicle 100 to change up a gear.

In embodiments the illuminable portion 30 comprises a light obscuration region 60 so that light emitted through the illuminable portion 30 has a non-uniform appearance. In embodiments, the light obscuration region 60 comprises an indicator indicative of gear shift direction selectable by operation of the gear shift paddle 300. Non-uniform appearance of the light transmitted coupled with the light obscuration region 60 comprising an indicator serves to highlight to the driver of the vehicle the functionality of a given one of the plurality of gear shift paddles 300.

A driving system for the vehicle 100, comprises the gear shift system 400 and a steering wheel 410. The steering wheel 410 comprises the second drive mode activation button 500 configured to cause the vehicle to transition to a second drive mode. The second drive mode activation button 500 comprises a second drive mode activation button illuminable portion 510. The second drive mode activation button illuminable portion 510 is configured to selectively illuminate in dependence on a given vehicle drive mode, as discussed. In a first drive mode the illuminable portion 510 of the second drive mode activation button 500 illuminates in a first colour. In a second drive mode the illuminable portion 510 of the second drive mode activation button 500 illuminates in a second, different, colour.

In embodiments the plurality of gear shift paddles 300 are not rotatably coupled to the steering wheel 410. Put another way, the gear shift paddles 300 are coupled to a fixed part of the steering column of the vehicle, and remain in a fixed position relative to the interior of the vehicle 100, when the steering wheel 410 is rotated. In an alternative embodiment the plurality of gear shift paddles 300 are supported by a rotating part of the steering column or steering wheel 410. Put another way, the gear shift paddles 300 are coupled to the steering wheel or other rotating component of the steering system, and move with the steering wheel 410 as it is rotated, in use.

The vehicle 100 comprises the gear shift system 400 or the driving system. In each of the first, second and third drive modes, a state of a plurality of further vehicle systems are modified, as discussed.

It will be appreciated that various changes and modifications can be made to the present invention without departing from the scope of the present application.

1. A gear shift system for a vehicle comprising a steering wheel, the gear shift system comprising:
a plurality of gear shift paddles associated with the steering wheel, each of the plurality of gear shift paddles being operable by a user of the vehicle to request a gear shift; wherein the plurality of gear shift paddles each comprise a illuminable portion.

2. The gear shift system of claim 1, wherein the illuminable portion is configured to selectively illuminate in dependence on a given vehicle drive mode, wherein:
in a first drive mode the illuminable portion of each of the plurality of gear shift paddles illuminates in a first colour, and
in a second drive mode the illuminable portion of each of the plurality of gear shift paddles illuminates in a second, different, colour.

3. The gear shift system of claim 1, wherein each gear shift paddle of the plurality of gear shift paddles comprises an LED, the LED configured to illuminate the illuminable portion of each gear shift paddle of the plurality of gear shift paddles.

4. The gear shift system of claim 1, wherein the illuminable portion comprises a transparent material or a translucent material.

5. The gear shift system of claim 3, wherein each gear shift paddle of the plurality of gear shift paddles comprises a light guide, the light guide configured to transmit light from the LED to illuminate the illuminable portion of each of the plurality of gear shift paddles.

6. The gear shift system of claim 3, wherein the illuminable portion comprises the LED.

7. The gear shift system of claim 1, wherein the gear shift requested by one of the plurality of gear shift paddles is a change-up gear shift, configured to cause a transmission of the vehicle to change to a higher gear, and the gear shift requested by another of the plurality of gear shift paddles is a change-down gear shift function, configured to cause the transmission of the vehicle to change to a lower gear.

8. The gear shift system of claim 1, wherein the gear shift requested by operation of each of the plurality of gear shift paddles in a first direction is a change-up gear shift, configured to cause a transmission of the vehicle to change to a higher gear, and the gear shift requested by operation of each of the plurality of gear shift paddles in a second, different, direction is a change-down gear shift, configured to cause the transmission of the vehicle to change to a lower gear.

9. The gear shift system of claim 2, wherein in a third drive mode the illuminable portion of each of the plurality of gear shift paddles does not illuminate.

10. The gear shift system of claim 3, wherein the illuminable portion comprises a light obscuration region so that light emitted through the illuminable portion has a non-uniform appearance.

11. The gear shift system of claim 10, wherein the light obscuration region comprises an indicator indicative of gear shift direction selectable by operation of the plurality of gear shift paddles.

12. A driving system for a vehicle, the driving system comprising:
the gear shift system of claim 1; and
a steering wheel, wherein the steering wheel comprises a second drive mode activation button configured to cause the vehicle to transition from a first drive mode to a second drive mode, and wherein the second drive mode activation button comprises:
a second drive mode activation button illuminable portion, the second drive mode activation button illuminable portion configured to selectively illuminate in dependence on a given vehicle drive mode, wherein:
in a first drive mode the illuminable portion of the second drive mode activation button illuminates in a first colour, and
in a second drive mode the illuminable portion of the second drive mode activation button illuminates in a second, different, colour.

13. The driving system of claim 12, wherein the plurality of gear shift paddles are not rotatably coupled to the steering wheel.

14. A vehicle comprising the gear shift system of claim 9.

15. The vehicle of claim 14, wherein in each of the first, second and third drive modes, a state of a plurality of further vehicle systems are modified.

16. A vehicle comprising the gear shift system of claim 1.
